(19) United States
(12) Patent Application Publication
(10) Pub. No.: US 2023/0265963 A1
(43) Pub. Date: Aug. 24, 2023

(54) Linkage Assembly for Balancing a Mechanical Arm

(71) Applicant: Brian Matthew Unger, Hillsbor, OR (US)

(72) Inventor: Brian Matthew Unger, Hillsbor, OR (US)

(21) Appl. No.: 17/679,078

(22) Filed: Feb. 23, 2022

(51) Int. Cl. F16M 11/06

(52) U.S. Cl. CPC F16M 11/06; F16M 2200/04; F16M 2200/06

(57) ABSTRACT

An articulating arm for balancing a tray for holding tools and equipment such as air tools, grinders, welders, vacuum, and electrical tools off the ground and movable horizontally and vertically to position the tools or equipment near a work area. The arm comprising a tray end and a mount end with an articulating parallelogram arm allowing the tray end to articulate vertically and horizontally with an adjustment mechanism configured to adjust a linkage that interacts with a spring such that the tray end vertically stays when it is released at any elevation.

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### PRIOR ART

U.S. Pat. No. 6,012,821 A
U.S. Pat. No. 6,571,969 B2
US20110127390 A1
U.S. Pat. No. 9,316,346B2
U.S. 11118729B2
EP3861958A1
U.S. Pat. No. 9,074,721B2
US20100092917A1
US20090314131A1
U.S. Pat. No. 5,340,072A
U.S. Pat. No. 5,579,071A
U.S. Pat. No. 5,884,880A
U.S. Pat. No. 5,435,515A

### FIELD OF THE INVENTION

This disclosure relates generally to mechanical arm assemblies for holding tools or equipment off the ground and movable horizontally and vertically typically to position the tools or equipment near the work area or to station the tools or equipment away from the work area. Tools or equipment generally require utilities such as air, gas, water, vacuum, or electrical routed through hoses, tubes, wires, lines or cables.

The terms “Utilities,” “air,” “gas,” “water.” “Vacuum,” and “electrical” may be used interchangeably to mean any form of utility used to operate tools or equipment. “Electrical” utilities may mean power such as 110v or 220v, high current for welding, low level signals, or any other form of power transfer. The terms “hoses,” “tubes,” “wires,” “lines,” or “cables” may be used interchangeably to mean any form of line used to carry utilities such as air, gas, water, vacuum, or electrical.

### BACKGROUND OF THE INVENTION

Work environments in which products are manufactured, detailed, reworked, or some other means of modification often have a work area which requires tools or equipment to be available to personnel working on a work piece and accessible to the work piece while also able to be moved out of the way of the work area when not in use. Many of the tools or equipment required include hoses, tubes, wires, or cables that provide air, gas, electrical, or other utilities to the tool or equipment. These hoses, tubes, wires, or cables typically come from outside of the work area and are pulled into the work area when the tool or equipment they are attached to is being used. Typically utilities are available from only one location of the work area which makes it difficult to access all parts of the work piece with the tools or equipment.

Running hoses, tubes, wires, or cables across the floor in a work area is a hazard that is difficult to avoid without adequate cable management. Some solutions comprise of mounting locations for the tools or equipment located near where the utilities come into the work area to keep the hoses, tubes, wires, or cables in a confined area while utilizing a rotating platform for providing access to all parts of the work piece. This minimizes hazards associated with the hoses, tubes, wires, or cables to a smaller area but does not eliminate them.

Some solutions comprise of mechanical arms configured to hold tools or equipment elevated above the ground near the work area at a fixed height which limits the operator's ability to position the tools in a preferred vertical location. Other solutions comprise of mechanical arms capable of articulating up and down to be positioned vertically in preferred locations with limited success in maintaining these vertical positions.

### SUMMARY OF THE INVENTION

Generally, disclosed is an articulating mechanical arm assembly for holding tools or equipment off the ground and movable horizontally and vertically to position the tools or equipment near a work area or to station the tools or equipment away from a work area. The mechanical arm has a means to adjust the load carrying capacity of a flexible portion and is configured to stay where it is left after moving it horizontally or vertically when adjusted properly.

The mechanical arm is comprised of a mount for mounting the mechanical arm to a mounting surface, a vertically rigid arm pivotally coupled to the mount and configured to remain substantially vertically rigid and swing horizontally about the mount, a vertically flexible parallelogram arm pivotally coupled to the vertically rigid arm at one end and configured to translate vertically at the other end, and a tool tray for holding tools or equipment, the tool tray pivotally coupled to the vertically translatable end of the vertically flexible parallelogram arm.

The parallelogram arm includes a first post member, a second post member, a first link member having a first end pivotally attached to the first post member and a second end pivotally attached to the second post member, and a second link member having a first end pivotally attached to the first post member and a second end pivotally attached to the second post member and arranged such that the first post member and the second post member remain substantially parallel.

The parallelogram arm further includes a connecting link member having a first end and a second end, the first end pivotally coupled to the first link member and translatable along the length of the first link member and the second end pivotally coupled to the first post member and translatable substantially toward and away from the first end of the first link member.

As the parallelogram arm articulates vertically, the end of the connecting link member slides along the length of the first connecting link. To prevent the parallelogram from collapsing vertically downward, the parallelogram arm includes a biasing spring configured to bias the first end of the connecting link member in a direction that prevents the parallelogram arm from collapsing vertically to the ground. Articulating the parallelogram arm vertically changes the geometry of the connecting link member relative to the first link member and first post member resulting in a different spring load required to hold the parallelogram arm in place. The biasing spring is sized to a specific spring rate and configured to have an effective spring rate on the first end of the connecting link member that substantially matches the change in biasing spring load required to hold the parallelogram arm in place at different vertical positions.

Adding or removing tools or weight on the tool tray changes the required spring rate and load needed at the first end of the connecting link member to hold the parallelogram arm in a vertical position. The parallelogram arm further includes an adjustment mechanism connected to the second end of the connecting link member and configured to move the second end of the connecting link member substantially toward and away from the first end of the first link member. Moving the second end of the connecting link member changes the effective spring rate of the biasing spring on the first end of the connecting link member. The adjustment mechanism comprises an anchor point pivotally coupled to the second end of the connecting link member and a screw thread coupled to the anchor point and configured to move the anchor point toward and away from the first end of the first connecting link.

Moving the anchor point closer to the first end of the first connecting link results in a lower effective spring rate of the biasing spring and a lower load capacity on the tool tray. Moving the anchor point further away from the end of the first connecting link results in a higher effective spring rate of the biasing spring and a higher load capacity on the tool tray.

### BRIEF DESCRIPTION OF THE DRAWINGS

FIG. 1 shows an isometric view of a linkage assembly for balancing a mechanical arm.

FIG. 2 shows a top view of a linkage assembly for balancing a mechanical arm.

FIG. 3 shows a front view of a linkage assembly for balancing a mechanical arm with a panel removed.

FIGS. 4a-4b show a section of balancing components of a linkage assembly for balancing a mechanical arm.

FIGS. 5a-5d show a linkage assembly for balancing a mechanical arm in 4 different configurations.

FIG. 6 shows a front view of a ceiling mounted linkage assembly for balancing a mechanical arm.

FIG. 7 shows a top view of ceiling mounted linkage assembly for balancing a mechanical arm.

FIG. 8a-8c shows a cross section views of a slip ring assembly for transferring utilities through a pivotable joint of a linkage assembly for balancing a mechanical arm.

FIG. 9 shows an isometric view of a ceiling mount linkage assembly for balancing a mechanical arm.

FIG. 10 shows a front view of a ceiling mounted linkage assembly for balancing a mechanical arm with a panel removed.

FIG. 11 shows an isometric view of an alternate embodiment of a linkage assembly for balancing a mechanical arm with a tray for air tools.

FIG. 12 shows a top view of an alternate embodiment of a linkage assembly for balancing a mechanical arm with a tray for air tools.

### DETAILED DESCRIPTION

As described above, designing a product that allows a user to maneuver tools and equipment, primarily tools and equipment with hoses, tubes, wires, or cables, with ease and without concern of tangling the hoses, tubes, wires, or cables, is important for many applications and is often necessary. In any application, especially in manufacturing environments, safety is a critical concern. Managing the hoses, tubes, wires, or cables can become a critical safety issue especially when more than one tool or piece of equipment is used in the work area requiring more than one hose, tube, wire, or cable.

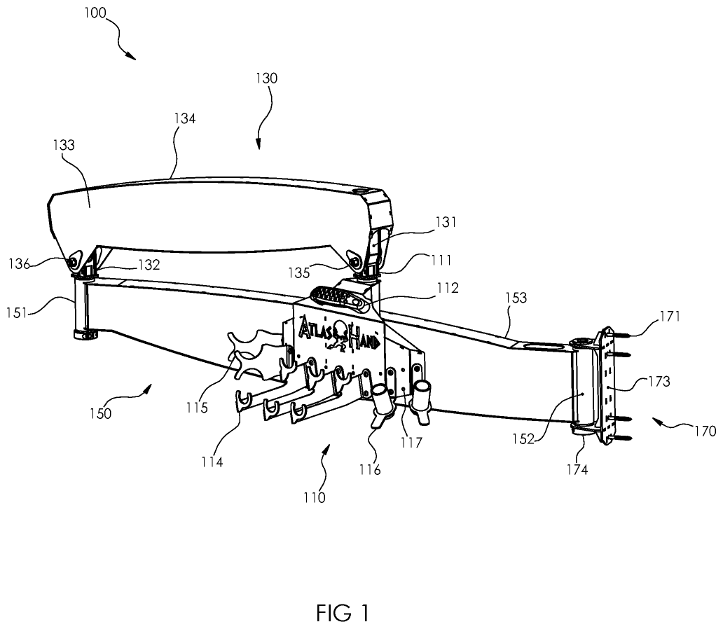

FIG. 1 shows an isometric view of a linkage assembly 100 which utilizes a parallelogram assembly 130 configured to hold tools or equipment stationary against gravity while freely allowing vertical and horizontal translation. Linkage assembly 100 includes a mounting assembly 170, a swing assembly 150, and a tray assembly 110. Other embodiments may include a plurality of parallelogram assemblies, a plurality of swing assemblies, or a tray assembly with any number of slots, holes, or mounting features for a plurality of tools or equipment.

This embodiment consists of mounting assembly 170 configured to mount to a wall or bench with a plurality of mounting fasteners 171 and a mounting surface 173. Other embodiments may comprise a series of holes configured to allow u-bolts to fasten mounting surface 173 against a post, pole, or similar mounting plane. This embodiment includes a mounting pivot axis 174 vertically oriented on mounting assembly 170 to allow swing assembly 150 to swing substantially along a horizontal plane. Mounting surface 173 is oriented substantially parallel to mounting pivot axis 174. Some embodiments comprise a mounting surface with an orientation perpendicular to mounting pivot axis 174 and configured to mount on a horizontal surface such as a ceiling, a floor, a tabletop, or a table underside.

Swing assembly 150 comprises a first pivot axis 151, a second pivot axis 152, and a connecting member 153 configured to rigidly hold first pivot axis 151 parallel to second pivot axis 152. This embodiment comprises connecting member 153 configured to hold first pivot axis 151 higher than second pivot axis 152. Other embodiments may include a connecting member configured to hold first pivot axis 151 lower than second pivot axis 152. Some embodiments may include a mounting location above second pivot axis 152 with a parallelogram assembly configured to mount below first pivot axis 151. This embodiment of linkage assembly 100 includes a single swing assembly 150. Other embodiments may comprise a plurality of swing assemblies configured to mount in series with each other allowing parallelogram assembly 130 and tray assembly 110 to extend further from mounting assembly 170.

Parallelogram assembly 130 includes a first post member 131, a second post member 132, a first link member 133, and a second link member 134, first link member 133 enclosed within second link member 134. Second link member 134 includes a first pivot 135 and a second pivot 136, first pivot 135 pivotally coupled to first post member 131 and second pivot 136 pivotally coupled to second post member 132. Second link member 134 is additionally pivotally coupled to first post member 131 and second post member 132 and configured to produce a parallelogram such that first post member 131 and second post member 132 stay substantially parallel throughout the vertical motion of parallelogram assembly 130. Second post member 132 is pivotally coupled to first pivot axis 151 of swing assembly 150 and is configured to hold parallelogram assembly 130 above swing assembly 150. Other embodiments may include a second post member pivotally coupled to first pivot axis 151 of swing assembly 150 and configured to hold parallelogram assembly 130 below swing assembly 150.

Tray assembly 110 includes a pivot axis 111, a handle 112, a plurality of air tool holders 114, a plurality of grinder holders 115, a plurality of welding tip holders 116, and a plurality of tool mounting locations 117. Pivot axis 111 of tray assembly 110 is substantially located at the back of tray assembly 110. Pivot axis 111 of tray assembly 110 is pivotally coupled to first post member 131 and configured to hold tray assembly 110 substantially below parallelogram assembly 133. Other embodiments may include a first post member 131 configured to hold pivot axis 111 and tray assembly 110 substantially above parallelogram assembly 130. Some embodiments may include a single handle located on the side, front or center of tray assembly 110. Some embodiments may comprise a plurality of tool or equipment holding features substantially on the sides or bottom of tray assembly 110. Other embodiments may include any kind of tool holder or feature for holding tools or equipment. Some embodiments may only include tool mounting locations 117 without tool holders while other embodiments may include trays for tool parts, no adjustable trays with fixed tool positions, or any feature capable of holding tools or equipment for an operator.

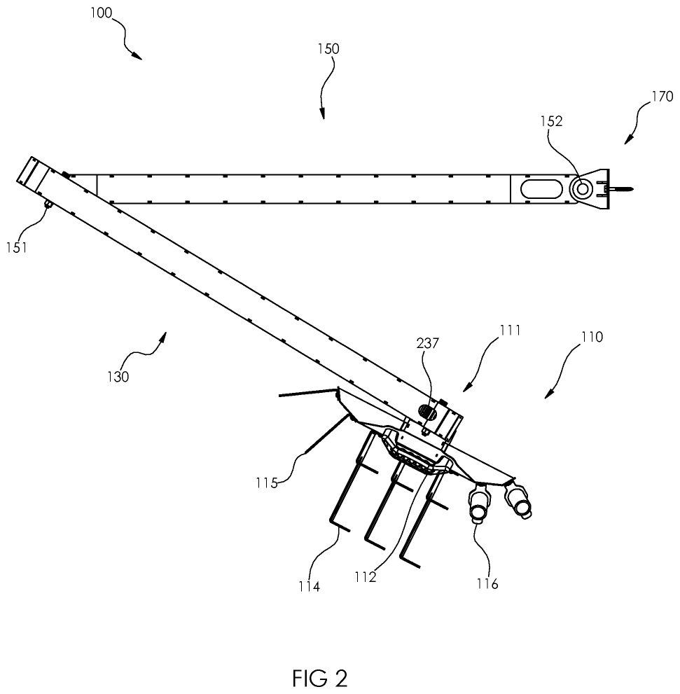

FIG. 2 shows a top view of linkage assembly 100. This embodiment includes mounting assembly 170 pivotally coupled to swing assembly 150 through first pivot axis 151 of swing assembly 150, parallelogram assembly 130 pivotally coupled to swing assembly 150 through second pivot axis of swing assembly 150, and tray assembly 110 pivotally coupled to parallelogram assembly 130 through pivot axis 111 of tray assembly 110. Parallelogram assembly 130 includes an adjustment location 237 for adjusting the balance of parallelogram assembly 130. Some embodiments may include a tool mount location for holding a tool used to adjust the balance of parallelogram assembly 130. Some embodiments may include an adjustment location near first pivot axis 151 of swing assembly 150.

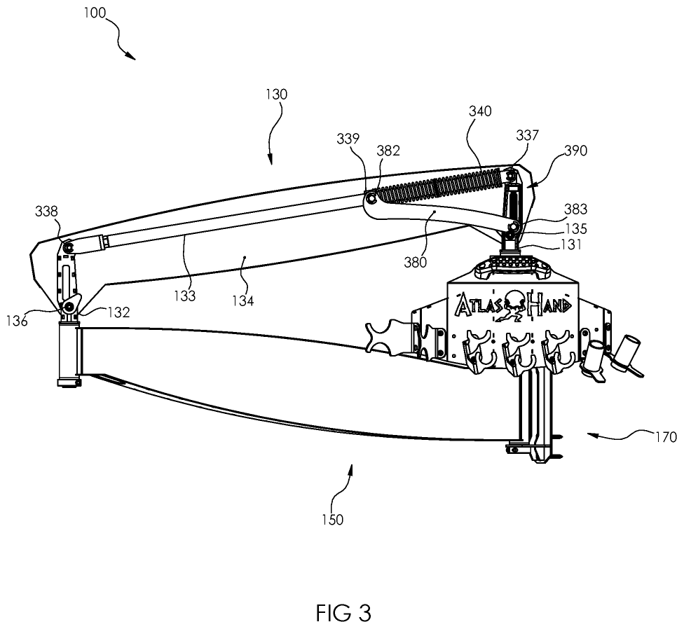

FIG. 3 shows linkage assembly 100 with the side of second link member 134 removed to show the inside of parallelogram assembly 130. Second link member 134 substantially encloses first link member 133, first post member 131 and second post member 132. Second link member 134 includes first pivot 135 located substantially at one end of second link member 134 and second pivot 136 located substantially at the opposite end of second link member 134, first pivot 135 of second link member 134 pivotally coupled to first post member 131 and second pivot 136 of second link member 134 pivotally coupled to second post member 132. First link member 133 includes a first pivot 337 substantially at one end of first link member 133 and a second pivot 338 substantially at the other end of first link member 133, first pivot 337 of first link member 133 pivotally coupled to first post member 131 and second pivot 338 of first link member 133 pivotally coupled to second post member 132 and configured such that first post member 131 and second post member 132 stay substantially parallel throughout vertical travel of tray assembly 110.

Parallelogram assembly 130 includes a connecting link member 380, a slider 339 coupled to first link member 133 and configured to translate along the length of first link member 133, a biasing member 340 coupled to first link member 133 and configured to provide a biasing force against slider 339 in the direction of translation of slider 339, and an adjustment mechanism 390. Connecting link member 380 includes a first end 382 pivotally coupled to slider 339 and a second end 383 pivotally coupled to adjustment mechanism 390, adjustment mechanism 390 configured to move second end 383 of connecting link member 380 substantially along the length of first post member 131.

The embodiment shown in FIG. 3 includes biasing member 340 producing a biasing force against slider 339 away from first pivot 337 of first link member 133 and towards second pivot 338 of first link member 133. Biasing member 340 in combination with connecting link member 380 and adjustment mechanism 390 act to reduce the angle between first link member 133 and first post member 131 and thereby creating a lifting force against gravity on tray assembly 110. Some embodiments include a connecting link member with a first end pivotally coupled to slider 339 and a second end pivotally coupled to an adjustment mechanism in second post member 132.

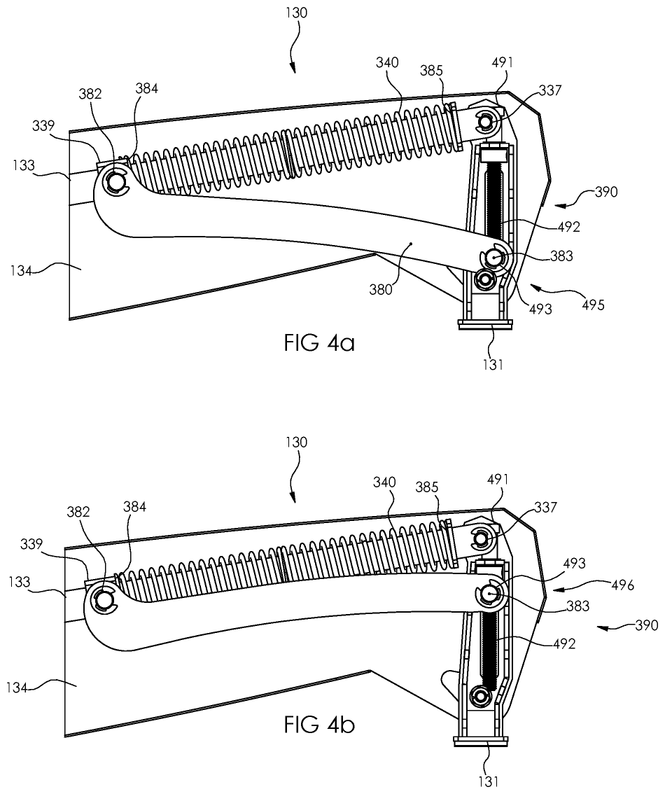

FIGS. 4a-4b show two different positions of adjustment mechanism 390 in parallelogram assembly 130. Adjustment mechanism 390 includes an adjustment screw 492 comprising an adjustment end 491 configured to accept a tool capable of transferring torque into adjustment screw 492 and an adjustment nut 493 configured to thread onto adjustment screw 492, adjustment screw 493 pivotally coupled to the second end 383 of link member 380. Adjustment mechanism 390 is configured to translate the second end 383 of link member 380 when a rotation is applied to adjustment end 491. Adjusting the location of second end 383 of link member 380 changes the effective spring rate of the biasing member 340 on parallelogram assembly 130 resulting in a system spring rate that is capable of matching the spring rate required to maintain balance of tray assembly 110 with different loads on tray assembly 110. Other embodiments include bolts, screws, or any threaded shaft capable of translating adjustment nut 493 substantially along the length of first post member 131 while some embodiments include adjustment mechanisms comprising a worm drive and worm gear or rack and pinion drive or any mechanism capable of controlling the translation of the second end 383 of link member 380. Some embodiments include an adjustment end below second end 383 of link member 380.

FIG. 4a shows a first position 495 of adjustment mechanism 390 and FIG. 4b shows a second position 496 of adjustment mechanism 390. Adjustment mechanism 390 is configured to be able to position second end 383 of link member 380 at any location between first position 495 and second position 496 of adjustment mechanism 390. Some embodiments may include a translation of second end 383 of link member 380 that is non-linear, angled, or any other means of translating between two points.

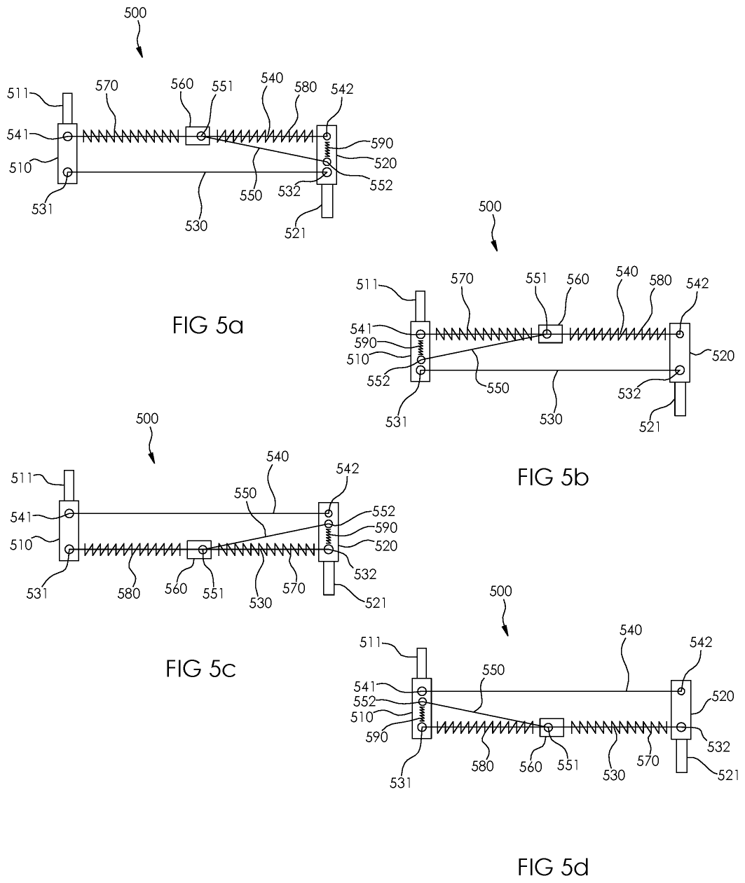

FIGS. 5a-5d show 4 arrangements of a parallelogram assembly 500. Parallelogram assembly 500 includes a left post member 510, a right post member 520, a bottom link member 530 and a top link member 540; bottom link member 530 comprising a left end 531 pivotally coupled to left post member 510 and a right end 532 pivotally coupled to right post member 520; top link member 540 comprising a left end 541 pivotally coupled to left post member 510 and a right end 542 pivotally coupled to right post member 520 and configured to hold right post member 520 substantially parallel to left post member 510 at various vertical positions of right post member 520 with respect to left post member 510. Left post member 510, right post member 520, bottom link member 530, and top link member 540 are pivotally coupled together and configured to substantially produce a parallelogram.

Left post member 510 includes a left post member pivot 511 configured to pivotally couple to a mounting location, a swing assembly, or some other arm or link member. This embodiment includes left post member pivot 511 substantially above parallelogram assembly 500. Other embodiments may include left post member pivot 511 substantially below parallelogram assembly 500. Right post member 520 includes a right post member pivot 521 configured to pivotally couple to a tray assembly, a swing assembly, or some other arm or link member. This embodiment includes right post member pivot 521 substantially below parallelogram assembly 500. Oher embodiments may include right post member pivot 521 substantially above parallelogram assembly 500.

FIG. 5a shows parallelogram assembly 500 with a slider 560 coupled to top link member 540 and translatable substantially along the length of top link member 540, a connecting link member 550 comprising a first end 551 pivotally coupled to slider 560 and a second end 552 pivotally coupled to an adjustment mechanism 590 and configured to translate substantially along the length of right post member 520, and one or more biasing members comprising a compression biasing member 580 or a tension biasing member 570 or both and configured to produce a biasing force against slider 560 substantially along the length of top link member 540 and toward left post member 510. Adjustment mechanism 590 is configured to adjust the location of second end 552 of connecting link member 550 substantially along the length of right post member 520.

FIG. 5b shows parallelogram assembly 500 with slider 560 coupled to top link member 540 and translatable substantially along the length of top link member 540, adjustment mechanism 590 coupled to left post member 510, connecting link member 550 pivotally coupled to slider 560 at its first end 551 and a pivotally coupled to adjustment mechanism 590 at its second end 552, and one or more biasing members comprising a compression biasing member 580 or a tension biasing member 570 or both and configured to produce a biasing force against slider 560 substantially along the length of top link member 540 and toward left post member 510. Adjustment mechanism 590 is configured to adjust the location of second end 552 of connecting link member 550 substantially along the length of left post member 510.

FIG. 5c shows parallelogram assembly 500 with slider 560 coupled to bottom link member 530 and translatable substantially along the length of bottom link member 530, adjustment mechanism 590 coupled to right post member 520, connecting link member 550 pivotally coupled to slider 560 at its first end 551 and a pivotally coupled to adjustment mechanism 590 at its second end 552, and one or more biasing members comprising a compression biasing member 580 or a tension biasing member 570 or both and configured to produce a biasing force against slider 560 substantially along the length of bottom link member 530 and toward right post member 520. Adjustment mechanism 590 is configured to adjust the location of second end 552 of connecting link member 550 substantially along the length of right post member 520.

FIG. 5c shows parallelogram assembly 500 with slider 560 coupled to bottom link member 530 and translatable substantially along the length of bottom link member 530, adjustment mechanism 590 coupled to left post member 510, connecting link member 550 pivotally coupled to slider 560 at its first end 551 and a pivotally coupled to adjustment mechanism 590 at its second end 552, and one or more biasing members comprising a compression biasing member 580 or a tension biasing member 570 or both and configured to produce a biasing force against slider 560 substantially along the length of bottom link member 530 and toward right post member 520. Adjustment mechanism 590 is configured to adjust the location of second end 552 of connecting link member 550 substantially along the length of left post member 510.

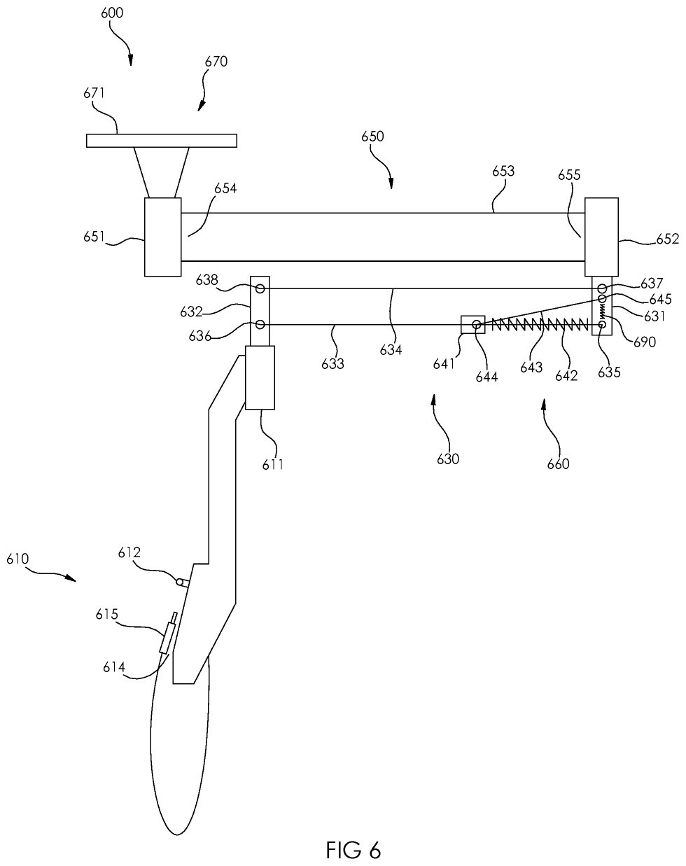

FIG. 6 shows a linkage assembly 600 comprising a mounting assembly 670, a swing assembly 650, a parallelogram assembly 630, and a tray assembly 610. Mounting assembly 670 includes a substantially horizontal mounting surface 671 configured to interface with a ceiling and fasten to it. Some embodiments include a substantially vertical mounting surface to mount to a wall or a mounting surface of any orientation configured to mount to a wall surface of similar orientation. Swing assembly 650 includes a first pivot 651 pivotally coupled to mounting assembly 670 and a second pivot 652 pivotally coupled to parallelogram assembly 630, first pivot 651 of swing assembly 650 substantially parallel to second pivot 652 of swing assembly 650. Tray assembly 610 includes a pivot axis 611 substantially at the top of tray assembly 610, pivot axis 611 pivotally coupled to parallelogram assembly 630 and configured to maintain a substantially vertical orientation. Parallelogram assembly 630 includes a parallelogram of linkage configured to hold pivot axis 611 of tray assembly 610 substantially vertical and parallel to second pivot 652 of swing assembly 650.

Swing assembly 650 includes a swing beam 653, a first end 654, and a second end 655, first end 654 rigidly coupled to first pivot 651 and second end 655 rigidly coupled to second pivot 652, swing beam 653 configured to hold second pivot 652 substantially parallel to first pivot 651 and hold second pivot 652 substantially at the same elevation as first pivot 651. Some embodiments may include a swing beam configured to hold second pivot 652 below first pivot 651. Other embodiments may include a swing beam configured to hold second pivot 652 above first pivot 651.

Parallelogram assembly 630 includes a first post member 631, a second post member 632. a first link member 633, a second link member 634, and a balancing assembly 660; first link member 633 comprising a first end 635 pivotally coupled to first post member 631 and a second end 636 pivotally coupled to second post member 632, second link member 634 comprising a first end 637 pivotally coupled to first post member 631 and a second end 638 pivotally coupled to second post member 632, second link member 634 configured to hold second post member 632 substantially parallel to first post member 631. Some embodiments include a second link member that fully or substantially encloses first post member. second post member, and first link member. Other embodiments include first post member comprising a substantially round cross section, rectangular cross section, hexagonal cross section, or any cross section that maintains consistent cross section along a length of second link member. Balancing assembly 640 includes a slider 641 coupled to first link member 633 and configured to translate along the length of first link member 633, a biasing member 642 configured to provide a biasing force on slider 641 along the length of first link member 633, a connecting link member 643 with a first end 644 pivotally coupled to slider 641 and a second end 645 pivotally coupled to an adjustment mechanism 690, adjustment mechanism 690 contained within first post member 631 and configured to translate second end 645 of connecting link member 643 along the length of first post member 631. Some embodiments include an adjustment mechanism contained within second post member and a connecting link with a second end pivotally coupled to an adjustment mechanism contained within the second post member. Other embodiments may include a slider coupled to second link member and translatable along the length of second link member and a biasing member configured to provide a force along the length of second link member.

Tray assembly 610 includes a handle 612, a plurality of too holders 614 substantially located at the front of tray assembly 610, and a plurality of tools 615. Handle 612 is located substantially in the center of tray assembly 610. Some embodiments may not include a handle. Other embodiments may comprise one or more handles located on the side or bottom of tray assembly 610. Some embodiments include tool holders located on the sides of tray assembly 610.

This embodiment includes a passage way through the center of tray assembly 610, second post member 632, parallelogram assembly 630, first post member 631, and swing assembly 650 allowing utilities such as water, pneumatic gas, welding gas, natural gas. electrical, signal lines, or high power lines to pass through.

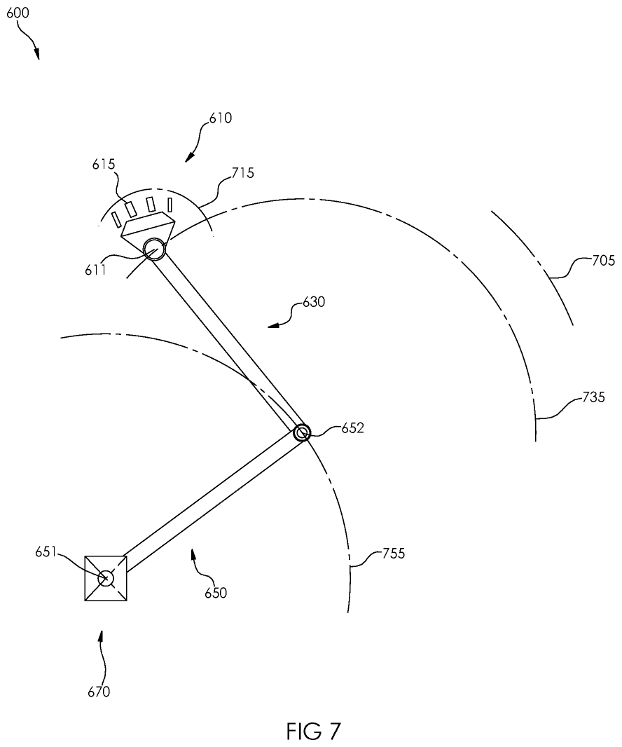

FIG. 7 shows a top view of link assembly 600 including swing assembly 650 with a swing radius 755 configured to swing around first pivot 651 of swing assembly 650, parallelogram assembly 630 with a parallelogram radius 735 configured to swing around second pivot 652 of swing assembly 650, and tray assembly 610 with a tray radius 715 configured to swing around tray axis 611. The combination of swing radius 755, parallelogram radius 735, and tray radius 715 creates a total radius 705 which is the total extent of the reach of tray assembly 610. This embodiment includes pivot points first pivot 651 of swing assembly 650, second pivot 652 of swing assembly 650, and tray axis 611 of tray assembly 610 comprised of slip rings allowing 360 degree rotation of the pivot points and allowing utilities to pass through the first pivot 651 of swing assembly 650, second pivot 652 of swing assembly 650, and tray axis 611 of tray assembly 610. Other embodiments may include pivot points that do not include slip rings or do not rotate a full 360 degrees.

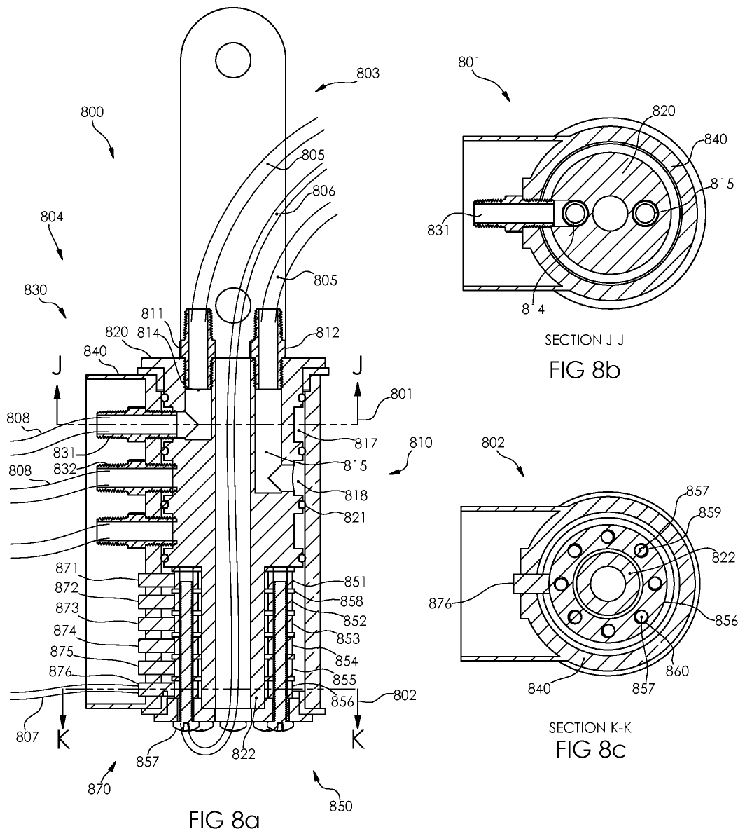

FIG. 8a shows a slip ring assembly 800 for use in linkage assembly 600, linkage assembly 100, or a similar linkage assembly; slip ring assembly 800 including a mounting side 803, a rotating side 804 configured to rotate about mounting side 803, a slip ring core assembly 810 coupled to mounting side 803 and configured to connect a plurality of gas utilities 805 from mounting side 803 to rotating side 804, a slip ring housing assembly 830 pivotally coupled to slip ring core assembly 810 and configured to connect a plurality of gas utilities 808 to slip ring core assembly 810, an electrical slip ring assembly 850 coupled to slip ring core assembly 810 and configured to connect a plurality of electrical utilities 806 from mounting side 803 to rotating side 804, and an electrical contact assembly 870 configured to connect electrical utilities 807 to electrical slip ring assembly 850.

Slip ring core assembly 810 includes a slip ring core 820, an electrical slip ring mount 822, and a plurality of o-ring seals 821 configured to maintain gas utilities transfer through slip ring pivot assembly 800; slip ring core 820 comprising a first gas fixed port 811. a first gas channel 817 comprising a substantially circular cross section about the center of slip ring core assembly 810, a first gas passage 814 configured to connect first gas fixed port 811 to first gas channel 817, a second gas fixed port 812, a second gas channel 818 comprising a substantially circular cross section about the center of slip ring core assembly 810, and a second gas passage 815 configured to connect second gas fixed port 812 to second gas channel 818. Electrical slip ring mount 822 is substantially located on the bottom of slip ring pivot assembly 800. Other embodiments may include an electrical slip ring mount located substantially at the top of a slip ring pivot assembly. This embodiment includes three gas utility transfers. Other embodiments may comprise one, two, three, or more gas fixed ports, gas passages, or gas channels.

Slip ring housing assembly 830 includes a slip ring housing 840 pivotably coupled to slip ring core assembly 810, a first gas rotating port 831, and a second gas rotating port 832; first gas rotating port 831 coupled to slip ring housing 840 and configured to interface with first gas channel 817 of slip ring core 820 and second gas rotating port 832 coupled to slip ring housing 840 and configured to interface with second gas channel 818 of slip ring core 820. First gas rotating port 831, second gas rotating port 832, and third gas rotating port 833 are configured to maintain orientation with slip ring housing 840 and rotate with slip ring housing 840 about slip ring core assembly 810. A plurality of utility lines 808 interface with first gas rotating port 831 and second gas rotating port 832. This embodiment comprises two gas utility lines and two gas rotating ports. Other embodiments may comprise one, two, three, four, or any number of gas utility lines and gas rotating ports. Some embodiments may be configured to run pneumatic gas, natural gas, welding gas, or any other type of gas.

Electrical slip ring assembly 850 includes a first power slip ring 851, a second power slip ring 852 substantially coaxial to first power slip ring 851, a third power slip ring 853 substantially coaxial to first power slip ring 851, a first welding slip ring 854 substantially coaxial to first power slip ring 851, a first signal slip ring 855 substantially coaxial to first power slip ring 851, and a second signal slip ring 856 substantially coaxial to first power slip ring 851. Other embodiments may include any number of power slip rings, welding slip rings, signal slip rings, or slip rings for any other type of electrical signal. Electrical slip ring assembly 850 includes a plurality of insulators 858 configured to insulate first power slip ring 851 from second power slip ring 852. second power slip ring 852 from third power slip ring 853, third power slip ring 853 from first welding slip ring 854, first welding slip ring 854 from first signal slip ring 855, and first signal slip ring 855 from second signal slip ring 856. Insulators 858 may also insulate first power slip ring 851 from slip ring core 820 and insulate second signal slip ring 856 from electrical slip ring mount 822. All the slip rings in electrical slip ring assembly 850 may be mounted around electrical slip ring mount 822. All the slip rings in electrical slip ring assembly 850 may be secured and mounted to slip ring core 820.

Electrical contact assembly 870 includes a first power electrical contact 871 configured to interface with first power slip ring 851, a second power electrical contact 872 configured to interface with second power slip ring 852, a third power electrical contact 873 configured to interface with third power slip ring 853, a welding electrical contact 874 configured to interface with first power slip ring 854. a first signal electrical contact 875 configured to interface with first signal slip ring 855, and a second signal electrical contact 876 configured to interface with second signal slip ring 856. The electrical contacts 871 through 876 may be coupled to slip ring housing 840 and configured to rotate about electrical slip ring assembly 850. Welding electrical contact 874 may be substantially larger than first power electrical contact 871, second power electrical contact 872, and third power electrical contact 873 to allow welding electrical contact 874 to carry more current. Slip ring housing 840 may comprise a portion of material which is insulative to electrical conduction or has a low electrical conductivity around the mounting areas of electrical contacts 871 through 876. This embodiment includes three power electrical contacts, one welding electrical contact, and two signal electrical contacts. Other embodiments may comprise any number of power electrical contacts, welding electrical contacts, or signal electrical contacts. First power electrical contact 871, second power electrical contact 872 and third power electrical contact 873 may be configured to transfer 25 amps at 110 volts or any other standard power rating. Welding electrical contact 874 may be configured to transfer 200 amps or more. First signal electrical contact 875 and second signal electrical contact 876 may be configured to transfer signal level power.

Electrical contacts 871 through 876 are configured to interface with a plurality of electrical utility lines 807, electrical utility lines 807 are configured to transfer electrical utilities through slip ring housing 840.

FIG. 8b shows a cross section 801 of slip ring assembly 800. Cross section 801 shows first gas passage 814 substantially opposite to second gas passage 815 around slip ring core 820. Other embodiments may comprise a plurality of gas passages located at any location or orientation around slip ring core 820. Slip ring housing 840 completely encloses slip ring core 820.

FIG. 8c shows a cross section 802 of slip ring assembly 800. Cross section 802 shows second signal electrical slip ring 856, second signal electrical contact 876 and a fastener 857 configured to secure second signal electrical slip ring 856 to slip ring electrical mounting 822 of slip ring core 820. This embodiment includes 8 fasteners 857 arranged circularly around slip ring electrical mounting 822. Second signal electrical contact 876 may be configured to interface with at least one fastener 857 at a fastener interface location 859 to create an electrical conduction path. Second signal electrical slip ring 856 may include at least one fastener clearance hole 860 to prevent fasteners 857 from creating an electrical conduction path.

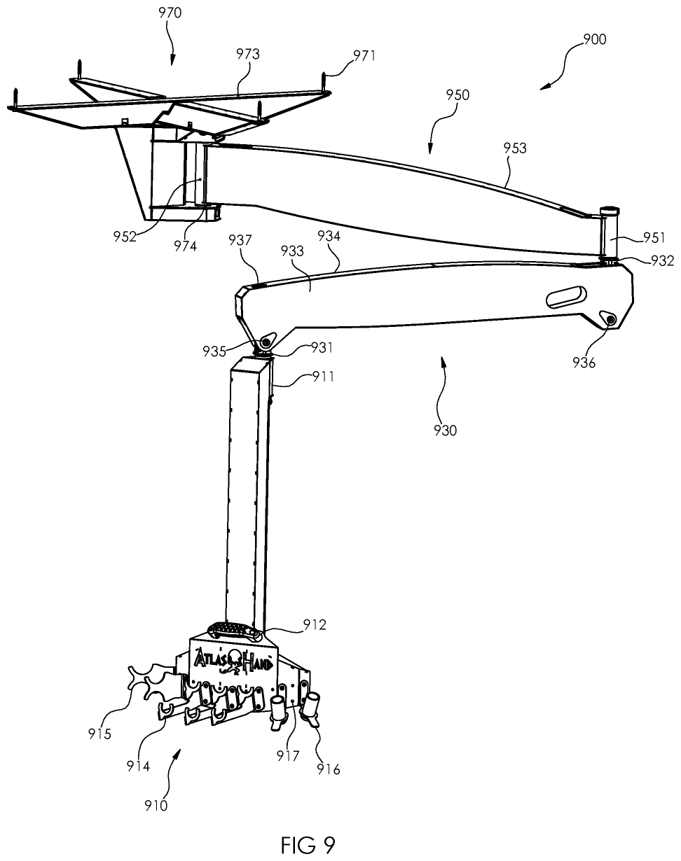

FIG. 9 shows an isometric view of a linkage assembly 900 which utilizes a parallelogram assembly 930 configured to hold tools or equipment stationary against gravity while freely allowing vertical and horizontal translation. Linkage assembly 900 includes a mounting assembly 970, a swing assembly 950, and a tray assembly 910. Other embodiments may include a plurality of parallelogram assemblies, a plurality of swing assemblies, or a tray assembly with any number of slots, holes, or mounting features for a plurality of tools or equipment.

This embodiment consists of mounting assembly 970 configured to mount to a ceiling with a top mounting fasteners 971 and a mounting surface 973. This embodiment includes a mounting pivot axis 974 vertically oriented on mounting assembly 970 to allow swing assembly 950 to swing substantially along a horizontal plane. Mounting surface 973 is oriented substantially perpendicular to mounting pivot axis 974. Some embodiments comprise a mounting surface with an orientation parallel to mounting pivot axis 974 and configured to mount on a vertical surface such as a wall or bench side.

Swing assembly 950 comprises a first pivot axis 951. a second pivot axis 952, and a connecting member 953 configured to rigidly hold first pivot axis 951 parallel to second pivot axis 952. This embodiment comprises connecting member 953 configured to hold first pivo axis 951 lower than second pivot axis 952. Other embodiments may include a connecting member configured to hold first pivot axis 951 higher than second pivot axis 952. Some embodiments may include a mounting location below second pivot axis 952 with a parallelogram assembly configured to mount above first pivot axis 951. This embodiment of linkage assembly 900 includes a single swing assembly 950. Other embodiments may comprise a plurality of swing assemblies configured to mount in series with each other allowing parallelogram assembly 930 and tray assembly 910 to extend further from mounting assembly 970.

Parallelogram assembly 930 includes a first post member 931, a second post member 932, a first link member 933, and a second link member 934 with first link member 933 enclosed by second link member 934. Second link member 934 includes a first pivot 935 and a second pivot 936, first pivot 935 pivotally coupled to first post member 931 and second pivot 936 pivotally coupled to second post member 932. First link member 933 is additionally pivotally coupled to first post member 931 and second post member 932 and configured to produce a parallelogram such that first post member 931 and second post member 932 stay substantially parallel throughout the vertical motion of parallelogram assembly 930. Second post member 932 is pivotally coupled to first pivot axis 951 of swing assembly 950 and is configured to hold parallelogram assembly 930 below swing assembly 950. Other embodiments may include a second post member pivotally coupled to first pivot axis 951 of swing assembly 950 and configured to hold parallelogram assembly 930 above swing assembly 950.

Tray assembly 910 includes a pivot axis 911, a handle 912, a plurality of air tool holders 914. a plurality of grinder holders 915, a plurality of welding torch tips 916 and a plurality of tool holder mounting locations 917. Pivot axis 911 of tray assembly 910 is substantially located at the back of tray assembly 910. Pivot axis 911 of tray assembly 910 is pivotally coupled to first post member 931 and configured to hold tray assembly 910 substantially below parallelogram assembly 933. Other embodiments may include a first post member 931 configured to hold pivot axis 911 and tray assembly 910 substantially above parallelogram assembly 930. Some embodiments may include a single handle located on the side, front or center of tray assembly 910. Some embodiments may comprise a plurality of tool or equipment holding features substantially on the sides or bottom of tray assembly 910.

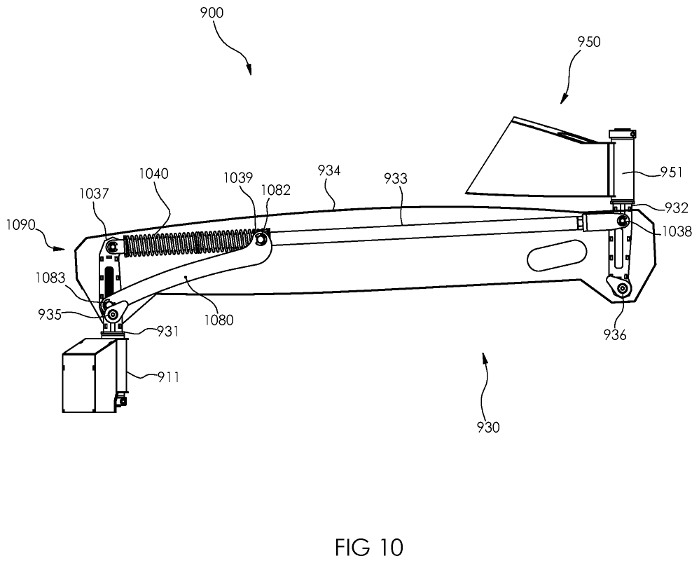

FIG. 10 shows linkage assembly 900 with the side of second link member 934 removed to show the inside of parallelogram assembly 930. Second link member 934 substantially encloses first link member 933, first post member 931 and second post member 932. Second link member 934 includes first pivot 935 located substantially at one end of second link member 934 and second pivot 936 located substantially at the opposite end of second link member 934, first pivot 935 of second link member 934 pivotally coupled to first post member 931 and second pivot 936 of second link member 934 pivotally coupled to second post member 932. First link member 933 includes a first pivot 1037 substantially at one end of first link member 933 and a second pivot 1038 substantially at the other end of first link member 933, first pivot 1037 of first link member 933 pivotally coupled to first post member 931 and second pivot 1038 of first link member 933 pivotally coupled to second post member 932 and configured such that first post member 931 and second post member 932 stay substantially parallel throughout vertical travel of tray assembly 910.

Parallelogram assembly 930 includes a connecting link member 1080, a slider 1039 coupled to first link member 933 and configured to translate along the length of first link member 933, a biasing member 1040 coupled to first link member 933 and configured to provide a biasing force against slider 1039 in the direction of translation of slider 1039, and an adjustment mechanism 1090. Connecting link member 1080 includes a first end 1082 pivotally coupled to slider 1039 and a second end 1083 pivotally coupled to adjustment mechanism 1090, adjustment mechanism 1090 configured to move second end 1083 of connecting link member 1080 substantially along the length of first post member 931.

The embodiment shown in FIG. 3 includes biasing member 1040 producing a biasing force against slider 1039 away from first pivot 1037 of first link member 933 and towards second pivot 1038 of first link member 933. Biasing member 1040 in combination with connecting link member 1080 and adjustment mechanism 1090 act to reduce the angle between first link member 933 and first post member 931 and thereby creating a lifting force against gravity on tray assembly 910. Some embodiments include a connecting link member with a first end pivotally coupled to slider 1039 and a second end pivotally coupled to an adjustment mechanism in second post member 932.

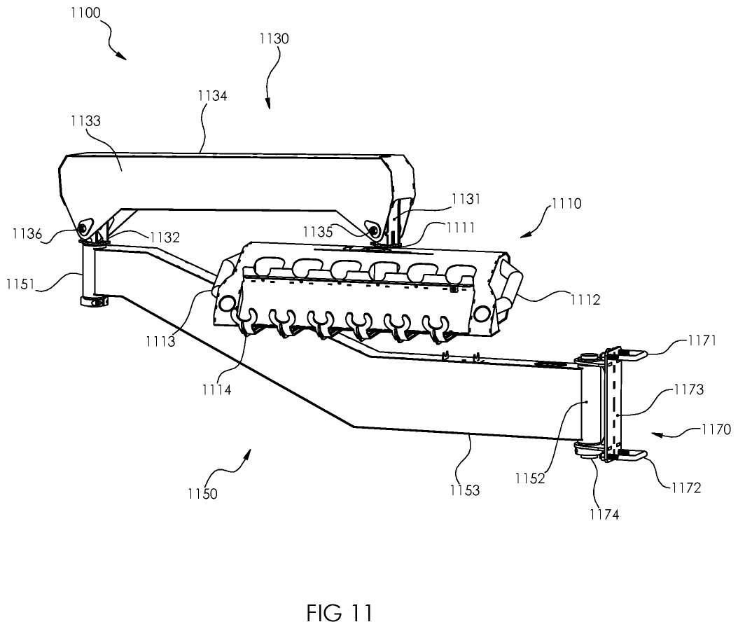

FIG. 11 shows an isometric view of a linkage assembly 1100 which utilizes a parallelogram assembly 1130 configured to hold air tools stationary against gravity while freely allowing vertical and horizontal translation. Linkage assembly 1100 includes a mounting assembly 1170, a swing assembly 1150, and a tray assembly 1110. Other embodiments may include a plurality of parallelogram assemblies, a plurality of swing assemblies, or a tray assembly with any number of slots, holes, or mounting features for a plurality of tools or equipment.

This embodiment consists of mounting assembly 1170 configured to mount to a pole or post with a top mounting u-bolt 1171, a bottom mounting u-bolt 1172, and a mounting surface 1173. Other embodiments may comprise a series of holes configured to allow bolts or screws to fasten mounting surface 1173 against a wall, vertical surface, or similar mounting plane. This embodiment includes a mounting pivot axis 1174 vertically oriented on mounting assembly 1170 to allow swing assembly 1150 to swing substantially along a horizontal plane. Mounting surface 1173 is oriented substantially parallel to mounting pivot axis 1174. Some embodiments comprise a mounting surface with an orientation perpendicular to mounting pivot axis 1174 and configured to mount on a horizontal surface such as a ceiling, a floor, a tabletop, or a table underside.

Swing assembly 1150 comprises a first pivot axis 1151, a second pivot axis 1152, and a connecting member 1153 configured to rigidly hold first pivot axis 1151 parallel to second pivot axis 1152. This embodiment comprises connecting member 1153 configured to hold first pivo axis 1151 higher than second pivot axis 1152. Other embodiments may include a connecting member configured to hold first pivot axis 1151 lower than second pivot axis 1152. Some embodiments may include a mounting location above second pivot axis 1152 with a parallelogram assembly configured to mount below first pivot axis 1151. This embodiment of linkage assembly 1100 includes a single swing assembly 1150. Other embodiments may comprise a plurality of swing assemblies configured to mount in series with each other allowing parallelogram assembly 1130 and tray assembly 1110 to extend further from mounting assembly 1170.

Parallelogram assembly 1130 includes a first post member 1131, a second post member 1132, a first link member 1133, and a second link member 1134, first link member 1133 enclosed within second link member 1134. Second link member 1134 includes a first pivot 1135 and a second pivot 1136, first pivot 1135 pivotally coupled to first post member 1131 and second pivot 1136 pivotally coupled to second post member 1132. Second link member 1134 is additionally pivotally coupled to first post member 1131 and second post member 1132 and configured to produce a parallelogram such that first post member 1131 and second post member 1132 stay substantially parallel throughout the vertical motion of parallelogram assembly 1130. Second post member 1132 is pivotally coupled to first pivot axis 1151 of swing assembly 1150 and is configured to hold parallelogram assembly 1130 above swing assembly 1150. Other embodiments may include a second post member pivotally coupled to first pivot axis 1151 of swing assembly 1150 and configured to hold parallelogram assembly 1130 below swing assembly 1150.

Tray assembly 1110 includes a pivot axis 1111, a first handle 1112, a second handle 1113, and a plurality of tool or equipment holding features 1114. Pivot axis 1111 of tray assembly 1110 is substantially located at the back of tray assembly 1110. Pivot axis 1111 of tray assembly 1110 is pivotally coupled to first post member 1131 and configured to hold tray assembly 1110 substantially below parallelogram assembly 1133. Other embodiments may include a first post member 1131 configured to hold pivot axis 1111 and tray assembly 1110 substantially above parallelogram assembly 1130. Some embodiments may include a single handle located on the side, front or center of tray assembly 1110. Some embodiments may comprise a plurality of tool or equipment holding features substantially on the sides or bottom of tray assembly 1110.

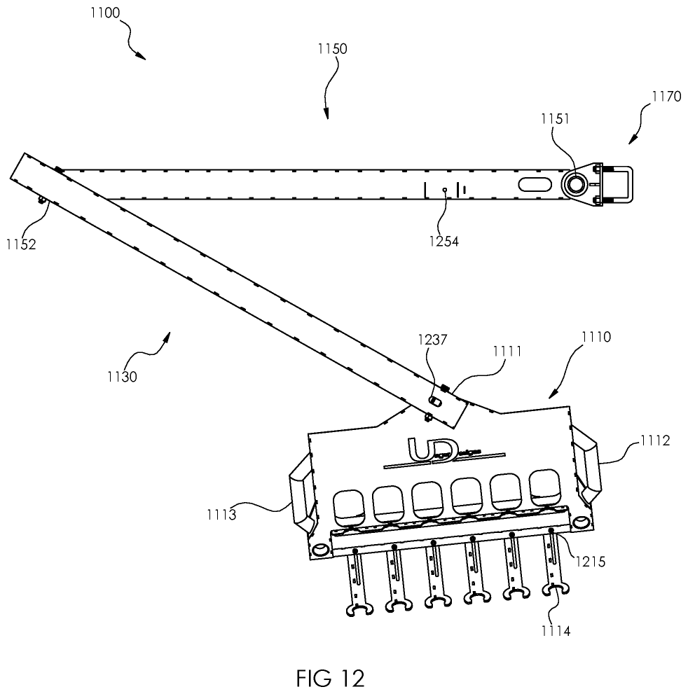

FIG. 12 shows a top view of linkage assembly 1100. This embodiment includes mounting assembly 1170 pivotally coupled to swing assembly 1150 through first pivot axis 1151 of swing assembly 1150, parallelogram assembly 1130 pivotally coupled to swing assembly 1150 through second pivot axis of swing assembly 1150, and tray assembly 1110 pivotally coupled to parallelogram assembly 1130 through pivot axis 1111 of tray assembly 1110. Parallelogram assembly 1130 includes an adjustment location 1237 for adjusting the balance of parallelogram assembly 1130. Swing assembly 1150 includes a tool mount location 1254 for holding a tool used to adjust the balance of parallelogram assembly 1130. Some embodiments may include an adjustment location near second pivot axis 1152 of swing assembly 1150. Tray assembly 1110 includes a tool holder adjustment 1215 to adjust the tool holder size of the tool or equipment holding features 1114.

Some embodiments have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings. it is not limited to these embodiments or drawings. Rather, the invention is intended to cover alternatives, modifications, and equivalents that come within the scope and spirit of the inventive principles set out herein.

The invention claimed is:

1. A linkage assembly for balancing a mechanical arm, comprising:
a first post member;
a second post member;
a first link member having a first end pivotally attached to the first post member, and a second end pivotally attached to the second post member;
a second link member having first end pivotally attached to the first post member and a second end pivotally attached the second post member, the first and second link member and the first and second post member arranged such that the first and second post members remain substantially parallel;
a connecting link member having a first end and a second end, the first end pivotally coupled to the first link member and translatable along the length of first link member, the second end pivotally coupled to the first post member and translatable substantially toward and away from the first end of the first link member;
a biasing member coupled to the first end of the connecting link member and configured to create a biasing force on the first end of the connecting link member along the length of the first link member; and
an adjustment mechanism connected to the second end of the connecting link member and configured to move the second end of the connecting link member substantially toward and away from the first end of the first link member.

2. The invention of claim 1, wherein the second link member has a length from the first end of the second link member to the second end of the second link member that is similar to the distance from the first end of the first link member to the second end of the first link member.

3. The invention of claim 2, wherein the first end of the first link member and the first end of the second link member are located on the first post member a similar distance apart to the location of the second end of the first link member relative to the second end of the second link member on the second post member.

4. The invention of claim 1, further comprising:
a sliding member pivotally coupled to the first end of the connecting link member and coupled to the first link member, the sliding member translatable along the length of the first link member.

5. The invention of claim 4, wherein the biasing member consists of a compression spring configured to push on the sliding member.

6. The invention of claim 4, wherein the biasing member consists of a tension spring configured to pull on the sliding member.

7. The invention of claim 1, further comprising:
a slot in the first post member, the slot oriented substantially towards the first end of the first link member;
an anchor point member pivotally coupled to the second end of the connecting link member and configured to slide along the slot in the first post member; and
a screw thread on the adjustment mechanism, the screw thread configured to move the anchor point member along the length of the slot in the first post member.

8. A method for balancing a mechanical arm, comprising:
providing a parallelogram linkage having two horizontal parallelogram members and two vertical parallelogram members, a connecting link member providing a first end pivotally coupled to one of the horizontal parallelogram members and a second end pivotally coupled to one of the vertical parallelogram members;
biasing the first end of the connecting link member along the length of the horizontal parallelogram member; and
moving the second end of the connecting link member substantially along the length of the vertical parallelogram member to change the effective spring rate of the biasing member on the parallelogram linkage.

9. The method of claim 8, further comprising:
rotating a screw relative to the vertical parallelogram member to translate the the second end of the connecting link member.

10. The method of claim 8, wherein biasing consists of pushing on the first end of the connecting link with a compression spring.

11. The method of claim 8, wherein biasing consists of pulling on the first end of the connecting link with a tension spring.

12. The method of claim 8, further comprising:
moving the parallelogram linkage up and down and releasing it

13. A linkage assembly for balancing a mechanical arm, comprising:
a post member;
an arm member having an end and a length, the end pivotally attached to the post member;
a connecting link member having a first end and a second end, the first end pivotally coupled to the arm member and translatable along the length of the arm member, the second end pivotally coupled to the post member and translatable substantially toward and away from the end of the arm member;
a biasing member coupled to the first end of the connecting link member and configured to create a biasing force on the first end of the connecting link member along the length of the arm member; and
an adjustment mechanism connected to the second end of the connecting link member and configured to move the second end of the connecting link member substantially toward and away from the end of the arm member.

14. The invention of claim 13, further comprising:
a sliding member pivotally coupled to the first end of the connecting link member and coupled to the arm member, the sliding member translatable along the length of the arm member.

15. The invention of claim 14, wherein the biasing member consists of a compression spring configured to push on the sliding member.

16. The invention of claim 14, wherein the biasing member consists of a tension spring configured to pull on the sliding member.

17. The invention of claim 13, further comprising:
a slot in the post member, the slot oriented substantially towards the end of the arm member;
an anchor point member pivotally coupled to the second end of the connecting link member and configured to slide along the slot in the post member; and
a screw thread on the adjustment mechanism, the screw thread configured to move the anchor point member along the length of the slot in the post member.
